(19) United States
(12) Patent Application Publication
(10) Pub. No.: US 2019/0389416 A1
(43) Pub. Date: Dec. 26, 2019

(54) HEAD-PROTECTING AIRBAG DEVICE

(71) Applicant: TOYODA GOSEI CO., LTD., Kiyosu-shi (JP)

(72) Inventor: Kenji KAKIMOTO, Kiyosu-shi (JP)

(21) Appl. No.: 16/442,712

(22) Filed: Jun. 17, 2019

(30) Foreign Application Priority Data
Jun. 25, 2018 (JP) 2018-120179

(51) Int. Cl. B60R 21/213; B60R 21/21; B60R 21/215; B60R 21/231; B60R 21/237

(52) U.S. Cl. CPC B60R 21/213; B60R 21/21; B60R 2021/0048; B60R 21/23138; B60R 21/237; B60R 21/215

(57) ABSTRACT

A head-protecting airbag device includes an airbag that includes an extended inflatable region which is deployable over an interior wall of the vehicle disposed beneath a beltline of the front side window. An airbag package, i.e. a folded configuration of the airbag, includes a rolled portion that is rolled in an up and down direction on an outboard side of the airbag. The airbag package includes a front-end region which is adapted to be stored in the front pillar and includes the extended inflatable region, and other general region. The front-end region is twisted towards an inboard direction at an angle under 90 degrees with respect to the general region in reference to a lower end of the airbag package.

### CROSS REFERENCE TO RELATED APPLICATIONS

The present application claims priority from Japanese Patent Application No. 2018-120179 of Kakimoto, filed on Jun. 25, 2018, the entire disclosure of which is incorporated herein by reference.

### BACKGROUND OF THE INVENTION

### 1. Field of the Invention

The present invention relates to a head-protecting airbag device including an airbag that is adapted to be mounted on upper peripheries of side windows in a folded-up configuration in an inboard side of a vehicle for deployment over the windows when fed with an inflation gas.

### 2. Description of Related Art

JP 2001-246998 A discloses a conventional head-protecting airbag device adapted to be mounted on upper peripheries of front and rear side windows of a vehicle. The airbag device includes an airbag that is folded to form an airbag package so as to be mounted on the upper peripheries of the side windows including a lower rim of the front pillar, in an inboard side of a vehicle. The airbag is designed to be deployed over the front side window, a middle pillar, the rear side window, and a rear pillar on the inboard side when fed with an inflation gas. In order that the airbag is smoothly deployed at the locations of the middle pillar and rear pillar as well despite the presence of pillar garnishes, portions of the airbag package disposed above the middle pillar and rear pillar are stored in such a state as twisted or rotated towards an inboard direction with respect to other general portion of the airbag package at an angle of 90 degrees in reference to a lower end of the airbag package.

However, such a configuration can cause a problem in an instance where the airbag includes, in a front portion to be stored in the front pillar, an extended region that is deployable downward beyond a beltline of a front door, i.e. a lower periphery of the front side window, such as a door trim. In such an instance, if the front portion of the airbag to be stored in the front pillar is twisted towards an inboard direction at an angle of 90 degrees with respect to the general portion, the portion may cause disengagement of a pillar garnish of the front pillar and let it fly in an interior of the vehicle. To the contrary, if the front portion of the airbag is mounted on the vehicle in a same way as the general portion, i.e. in an untwisted state with respect to the general portion, when the front side window is open, a lower end region of the extended region in the front portion of the airbag may protrude outwardly from the open window since a distance between a mounted position in the front pillar which slopes down forward and the door trim is short. This will lead to failure of protection of a head of an occupant.

### SUMMARY OF THE INVENTION

The present invention contemplates a solution to the above-mentioned problem, and has an object to provide a head-protecting airbag device which is able to deploy its airbag smoothly although the airbag includes an extended inflatable region which extends downward beyond the beltline in the front end portion.

The head-protecting airbag device of the invention is adapted to be mounted on a vehicle which has, on a side, a front pillar, a front side window, a middle pillar, a rear side window, and a beltline which forms a lower edge of the front side window. The front pillar extends obliquely upward toward a rear of the vehicle.

The airbag device of the invention includes an airbag that is, in the form of a folded airbag package, adapted to be mounted on an upper periphery of the front side window including a lower rim of the front pillar, and in an upper periphery of the rear side window, on an inboard side, so as to unfold downward and be deployed over at least the front side window, the middle pillar, and the rear side window, when fed with an inflation gas.

The airbag includes an extended inflatable region which is disposed in a front end portion of the airbag and is deployable over an interior wall of the vehicle disposed immediately beneath the beltline. The airbag package includes a rolled portion that is rolled in an up and down direction on an outboard side of the airbag, and the rolled portion includes a front-end region that is adapted to be stored in the front pillar, the extended inflatable region being disposed in the front-end region, and a general region that is disposed at the rear of the front-end region. The front-end region is twisted towards an inboard direction at an angle under 90 degrees with respect to the general region in reference to a lower end of the airbag package.

In the head-protecting airbag device of the invention, although the front-end region of the rolled portion, which includes the extended inflatable region deployable farther downwardly than the beltline of the front side window, is twisted towards the inboard direction with respect to the general region, the twisted angle is under 90 degrees. This configuration is able to deploy the airbag towards the inboard direction without breaking the front pillar garnish and/or letting it fly towards the interior of the vehicle. Further, since the front-end region of the rolled portion is twisted towards the inboard direction with respect to the general region, the extended inflatable region of the front-end region in the rolled portion is deployed over the interior wall disposed immediately beneath the beltline of the front side window, not on the outboard side, even if the front side window is open. Therefore, the airbag is able to arrest a vehicle occupant which moves towards an outboard direction in a steady fashion.

Therefore, the head-protecting airbag device of the invention is able to deploy the airbag smoothly although the airbag includes a portion deployable downward beyond the beltline in the front end portion.

In the head-protecting airbag device of the invention, it is desired that the front-end region of the rolled portion is twisted towards the inboard direction at an angle under 45 degrees with respect to the general region.

This configuration will further enable the extended inflatable region to be deployed over the interior wall of the vehicle beneath the beltline of the front side window even if the window is open, without a fear of breakage and/or disengagement of the front pillar garnish.

In the head-protecting airbag device of the invention, it is further desired that the airbag package is stored in one or more cases and fastened together with the cases with one or more fastening members that are configured to stop fastening at airbag deployment, and that one of the fastening members is disposed at a starting point of twisting of the front-end region.

With this configuration, the front-end region and general region in the airbag package and the cases are coupled together with the fastening bands in a steady fashion, and the one of the fastening members disposed at the starting point of twisting of the front-end region securely fixes the starting point of the twisting, and delimits the twisted front-end region from the untwisted general region in a steady fashion. This will help deploy each of the front-end region and general region in a desired deployment fashion.

In the head-protecting airbag device of the invention, it is further desired that the airbag package is configured such that an initial deployment direction of the front-end region, which is a direction that the front-end region deploys in an initial stage of airbag deployment, is directed towards an inboard direction with respect to a vertical direction, whereas an initial deployment direction of the general region, which is a direction that the general region deploys in the initial stage of airbag deployment, is directed towards an outboard direction, with respect to the vertical direction.

This configuration will steadily deploy the front-end region of the airbag package towards an inboard direction and deploy the general region towards an outboard direction in the initial stage of airbag deployment. As a consequence, the extended inflatable region will be steadily deployed over the interior wall of the vehicle beneath the beltline of the front side window, while the general region of the airbag package will be smoothly deployed along the middle pillar and rear side window, such that the airbag is deployed between the rear side window and the head of an occupant even if the head is located in proximity to the rear side window.

In the above instance, it is desired that:

the airbag further includes an initial unfolding region that is disposed in an upper edge of the airbag and receives an inflation gas initially, and that is folded into a concertina on a plurality of creases extending in a front and rear direction, thus forming a concertina-fold portion;

the concertina-fold portion is disposed over an upper surface of the rolled portion of the airbag package and includes an overlaid portion which is a portion disposed between adjoining creases of the concertina-fold portion; and in each of the front-end region and general region, the initial deployment direction is determined by a direction that heads towards a center of the rolled portion from a center in a vehicle-width direction of the overlaid portion.

With the above configuration, when an inflation gas flows into the initial unfolding region in the initial stage of airbag deployment, in each of the front-end region and general region, the overlaid portion of the initial unfolding region pushes the rolled portion towards the direction heading towards the center of the rolled portion from the center in the vehicle-width direction of the overlaid portion. The direction determines the initial deployment direction. Accordingly, each of the front-end region and general region can be mounted on the vehicle so as to be deployed in a desired initial deployment direction by arranging the overlaid portion of the concertina-fold portion in each of the front-end region and general region at a corresponding position when mounting the airbag package on the vehicle.

### BRIEF DESCRIPTION OF DRAWINGS

FIG. 1 is a schematic front elevation of a head-protecting airbag device embodying the invention, as viewed from an interior of a vehicle;

FIG. 2 is a schematic vertical sectional view of the airbag device of FIG. 1 taken along line II-II of FIG. 1;

FIG. 3 is a schematic vertical sectional view taken along line III-III of FIG. 1;

FIG. 4 is a front elevation of an airbag of the embodiment as laid flat;

FIG. 5 illustrates a folding process of the airbag of FIG. 4;

FIG. 6 is a front elevation of the airbag of FIG. 4 as folded and stored in cases;

FIG. 7 is an enlarged front elevation of a front portion of an airbag module;

FIG. 8 is a front elevation of the head-protecting airbag device of the illustrated embodiment as mounted in an upper periphery of a front side window;

FIG. 9A is a schematic vertical sectional view of the airbag device of the illustrated embodiment as actuated; and

FIG. 9B is a schematic vertical sectional view of an airbag device of a comparative example as actuated.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

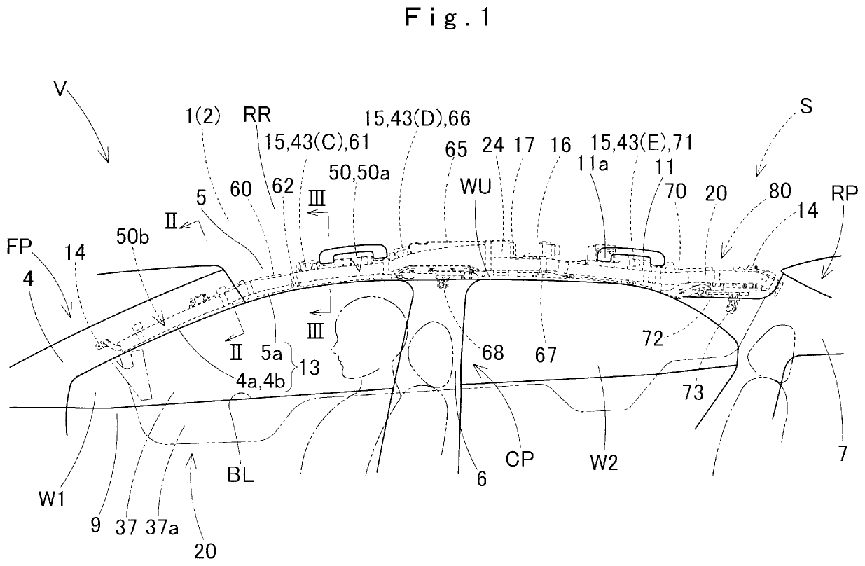

As shown in FIG. 1, a head-protecting airbag device S embodying the invention is mounted on a vehicle V which has two rows of seats and two, front and rear side windows W1 and W2. The head-protecting airbag device S includes an airbag 20, an inflator 16, an airbag cover 13, and cases 60, 65 and 70 for storing the airbag 20 in a folded-up configuration. The cases 60, 65 and 70 are fabricated from synthetic resin. The airbag 20 is adapted to be stored in upper peripheries WU of the windows W1 and W2 in an inboard side of the vehicle V in a folded-up configuration. Specifically, the airbag 20 is disposed at an area ranging from a lower rim of a front pillar FP through a region above a rear pillar RP, via a lower rim of a roof side rail RR.

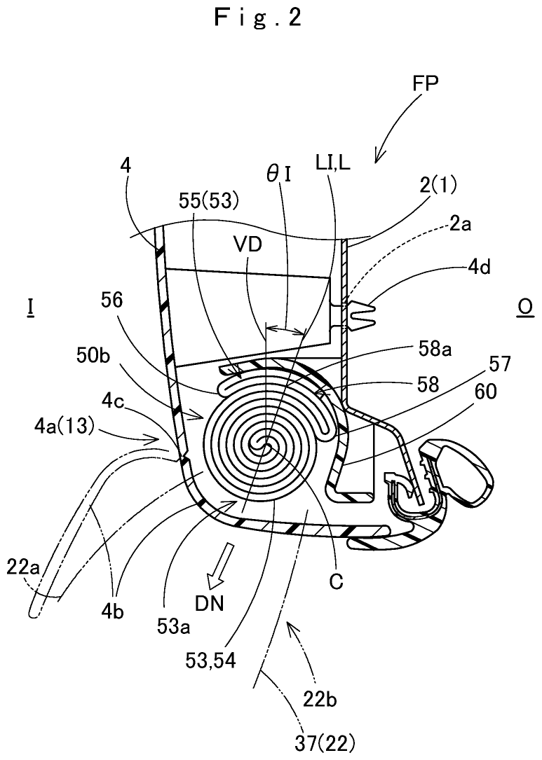

As shown in FIGS. 1 to 3, the airbag cover 13 is composed of a lower rim 4a of a front pillar garnish 4 arranged on the front pillar FP and a lower rim 5a of a roof head liner 5 arranged on the roof side rail RR. The front pillar garnish 4 and roof head liner 5 are each fabricated of synthetic resin, and secured to an inboard side of an inner panel 2 of a vehicle body structure 1, at the front pillar FP and roof side rail RR. The airbag cover 13 covers an inboard side of the airbag 20 stored in a folded-up configuration, and is designed to open towards an interior of the vehicle V when pushed by the airbag 20 in order to allow the airbag 20 to be deployed downward. As shown in FIG. 2, the front pillar garnish 4 includes a door portion 4b in the lower end region 4a, which is openable towards the interior of the vehicle V, and a hinge portion 4c which is a thinned integral hinge and allows the door portion 4b to open. A later-described front-end folded region 50b of the airbag 20 is stored in a front region of the door portion 4b. The front pillar garnish 4 further includes, on the back side, a clip 4d which is adapted to be inserted into a mounting hole 2a of the inner panel 2. The pillar garnish 4 is secured to the inner panel 2 by the clip 4d.

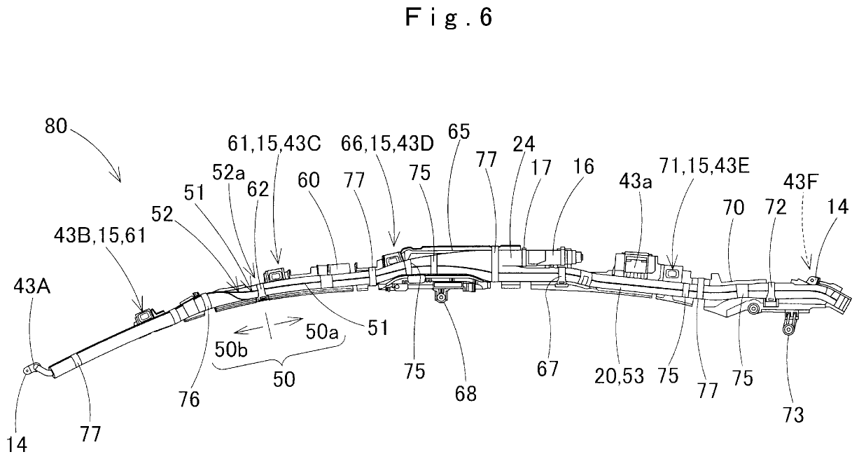

The inflator 16 is designed to feed the airbag 20 with an inflation gas. As shown in FIGS. 1 and 6, the inflator 16 is substantially cylindrical in outer contour, and includes not-shown gas discharge ports at the leading end region. The leading end region of the inflator 16 including the gas discharge ports is inserted into a later-described inlet port section 24 of the airbag 20, and a clamp 17 is used to fasten the inlet port section 24 and inflator 16, thus the inflator 16 is coupled with the airbag 20. The inflator 16 is secured to the inner panel 2 at a position above the rear side window W2 through the use of a not-shown predetermined mounting bracket. The inflator 16 is electrically connected to a not-shown control device of the vehicle V through a not-shown lead wire, and is designed to be actuated by an actuating signal fed from the control device as has detected a side impact, an oblique impact or a rollover of the vehicle V.

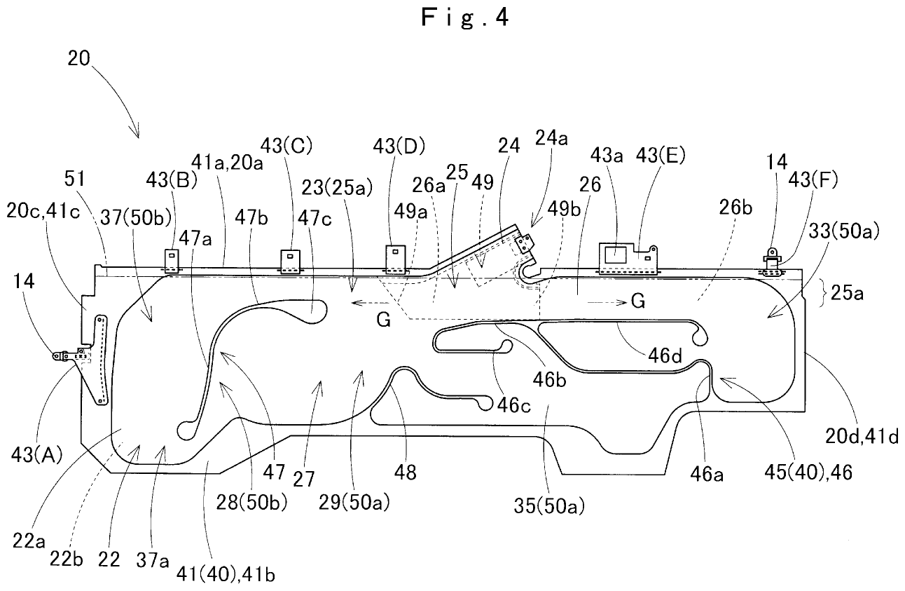

As shown in FIG. 4, the airbag 20 includes a gas receivable region 22 that is inflatable with an inflation gas G by separating an inboard side wall 22a from an outboard side wall 22b, and a non-receptive region 40 in which the inboard side wall 22a and outboard side wall 22b are attached together such that no inflation gas is admitted.

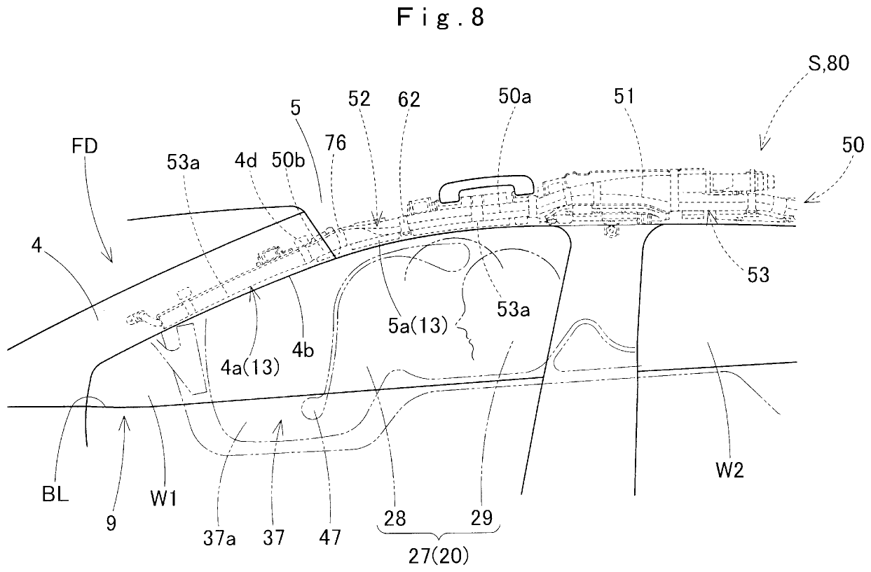

The gas receivable region 22 includes an unfoldable region 25 which is unfoldable from the folded-up configuration for covering the windows W1 and W2, and an inlet port section 24 which protrudes upward from a vicinity of the center in a front and rear direction of an upper edge 20a of the airbag 20 for connection with the inflator 16. The unfoldable region 25 includes a gas feed path 26 which is disposed along the upper edge 20a of the airbag 20 and in gas communication with the inlet port section 24 for feeding an inflation gas towards the front and rear, a front inflatable region 27 which covers an inboard side of the front side window W1, a rear inflatable region 33 which covers inboard sides of the rear side window W2 and rear pillar RP, a middle inflatable region 35 which covers inboard sides of the middle pillar CP and a front portion of the rear side window W2, and a front-end inflatable region 37 which is disposed at the front end region. As shown in FIGS. 1 and 8, the front-end inflatable region 37 extends farther downwardly than a beltline BL, i.e. a lower periphery of the front side window W1, and covers an interior wall of the vehicle beneath the beltline BL such as a door trim 9, when deployed.

In the illustrated embodiment, as indicated with broken lines in FIG. 4, an inner tube 49 is disposed inside the inlet port section 24. The inner tube 49 has a trifurcate contour. An inflation gas flowing into the inlet port section 24 from an opening 24a is released from openings 49a and 49b which are disposed at front and rear portion of a lower portion of the inner tube 49, and flows towards a front end 26a and a rear end 26b of the gas feed path 26, and further flows into the front inflatable region 27 and rear inflatable region 33.

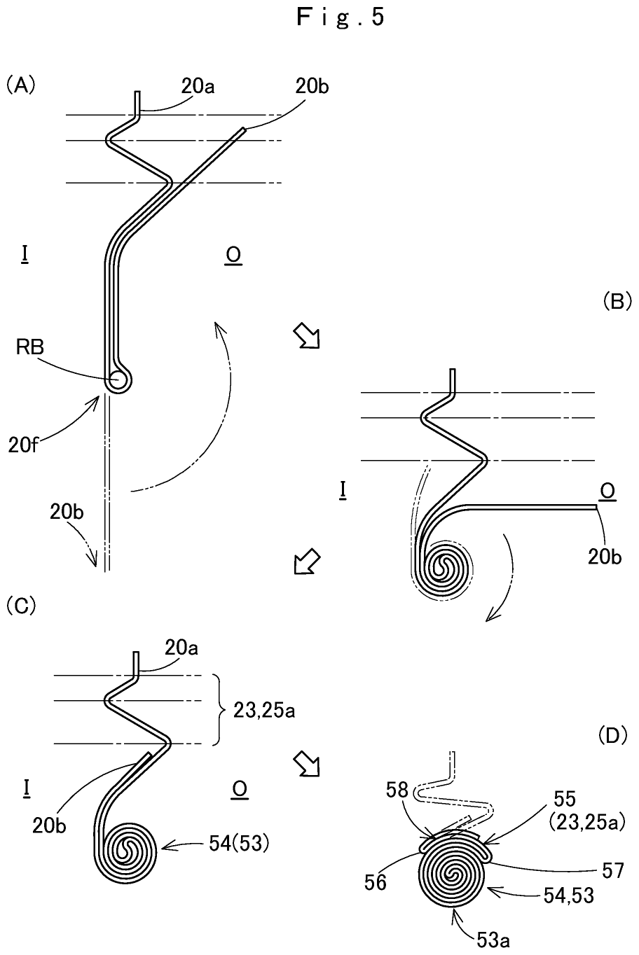

In the illustrated embodiment, an upper region 25a of the unfoldable region 25 including the gas feed path 26 is folded into concertina on creases 56 and 57 extending in a front and rear direction as shown in FIG. 5, and forms a concertina-fold portion 55. As the inflation gas flowing into the inlet port section 24 from the inflator 16 firstly flows into the concertina-fold portion 55, the concertina-fold portion 55 serves as an initial unfolding region 23.

The airbag 20 of the illustrated embodiment is folded to form an airbag package 53 for mounting in the peripheries of the windows W1 and W2. The front-end inflatable region 37 and a front end 28 portion of the front inflatable region 27 form a front-end folded region 50b of the airbag package 53 that is stored inside the front pillar FP and covered with the door portion 4b of the front pillar garnish 4. As described later, the front-end folded region 50b is twisted towards an inboard direction with respect to a general folded region 50a which is disposed at the rear of the front-end folded region 50b in reference to a lower end 53a of the airbag package 53. The non-receptive region 40 includes a peripheral region 41 which is disposed in a periphery of the gas receivable region 22, and a thickness-regulating portion 45 which is disposed in an area below the inlet port section 24 of the unfoldable region 25 for regulating a thickness of inflatable regions. The peripheral region 41 is provided with a plurality of mounting portions 43 (43A, 43B, 43C, 43D, 43E and 43F) which are mounted on the upper peripheries WU of the windows W1 and W2.

The peripheral region 41 is disposed around the gas receivable region 22, and includes an upper edge portion 41a, a lower edge portion 41b, a front edge portion 41c, and a rear edge potion 41d which correspond to upper, lower, front and rear edges 20a, 20b, 20c and 20d of the airbag 20. The upper edge portion 41a is provided with five mounting portions 43 (43B, 43C, 43D, 43E and 43F). The mounting portion 43F, which is disposed in a vicinity of the rear edge portion 41d, is formed into a belt extending upward. The front edge portion 41c is provided with the mounting portion 43A which extends forward in the shape of a belt. A mounting bracket 14 which is formed of sheet metal into an annular shape is attached to each of these belt-shaped mounting portions 43A and 43F. Each of the mounting brackets 14 is secured to the inner panel 2 with not-shown bolt in the upper periphery WU of the window W1, W2. A clip 15 made from synthetic resin is attached to each of other mounting portions 43B, 43C, 43D and 43E. The mounting portions 43B, 43C, 43D and 43E are each secured to the inner panel 2 with the clips 15 together with later-described mounting seats 61, 66 and 71 of the cases 60, 65 or 70 in the upper peripheries WU of the windows W1 and W2, as shown in FIG. 1.

As shown in FIG. 1, the mounting portion 43E includes a fitting hole 43a which is adapted to be retained by a front mounting portion 11a of a rear assist grip 11. Secured to the inner panel 2 not only by the clip 15 but also by retention with the front mounting portion 11a of the assist grip 11, the mounting portion 43E is prevented from slippage in position.

The thickness-regulating portion 45 includes a center shutter portion 46 which partitions the rear inflatable region 33 from the middle inflatable region 35 immediately below the gas feed path 26, a front shutter portion 47 which partitions the front inflatable region 27 from the front-end inflatable region 37, and a lower shutter region 48 which extends upwardly from the lower edge portion 41b of the peripheral region 41 and partitions the front inflatable region 27 from the middle inflatable region 35.

The center shutter portion 46 includes a vertical portion 46a which extends upward in a curving fashion from a rear region of the lower edge portion 41b of the peripheral region 41 and partitions the rear inflatable region 33 from the middle inflatable region 35, and a front horizontal portion 46b and a rear horizontal portion 46d which extend each forward and rearward from an upper end of the vertical portion 46a and define a lower edge of the gas feed path 26. The front horizontal portion 46b includes, in the front end region, a turnabout portion 46c which extends rearwardly and downwardly and goes into the middle inflatable region 35.

The front shutter portion 47 is disposed between the upper edge portion 41a and lower edge portion 41b of the peripheral region 41, remote from the upper edge portion 41a and lower edge portion 41b. The front shutter portion 47 includes a vertical portion 47a which extends generally in an up and down direction, and a horizontal portion 47b which extends rearwardly in a curving fashion from an upper end of the vertical portion 47a. The horizontal portion 47b is formed into a semicircle which increases in width in an up and down direction towards the rear end 47c. The lower shutter region 48 extends diagonally rearwardly and upwardly from the lower edge portion 41b of the peripheral region 41, and further extends rearward in such a manner as to go into the middle inflatable region 35.

Mounting of the head-protecting airbag device S on the vehicle V is now described. Firstly, the mounting brackets 14 are attached to the mounting portions 43A and 43F of the airbag 20, and the airbag 20 as laid flat is rolled and folded to form an airbag package 53 such that the dimension in an up and down direction is reduced, as shown in FIG. 5. To describe the folding and rolling of the airbag 20 of the illustrated embodiment more specifically, a rolling-assistance bar RB is placed in a middle region 20f in the up and down direction of the airbag 20 as laid flat, and the lower edge 20b region of the airbag 20 is folded back towards the upper edge 20a region at the location of the rolling-assistance bar RB, as shown in (A) and (B) of FIG. 5. With the aid of the rolling-assistance bar RB, the airbag 20 is then rolled on the outboard side (i.e. towards an outboard direction O) from the middle region 20f. Thus a rolled portion 54 is formed.

In the illustrated embodiment, after the airbag 20 is rolled as described above and as shown in (A) and (B) of FIG. 5, the lower edge 20b region is turned around towards the inboard side as shown in (B) and (C) of FIG. 5, then the initial unfolding region 23 is folded into concertina on an inboard-side crease 56 and an outboard-side crease 57 both of which extend in a front and rear direction, thus a concertina-fold portion 55 is formed. Then a portion of the concertina-fold portion 55 disposed between the creases 56 and 57, namely an overlaid portion 58, is placed over an upper surface of the rolled portion 54, as shown in (D) of FIG. 5. Thus the airbag package 53 is formed.

Then referring to FIG. 6, the airbag package 53 is bound with a tape (as a fastening member) 75 at predetermined positions for keeping the folded-up configuration, and is stored in the cases 60, 65 and 70. The cases 60, 65 and 70 as housing the airbag package 53 are each bound with a fastening band (as fastening member) 62, 67 and 72 for fastening the airbag package 53 to the cases 60, 65 and 70, and further tapes 76 and 77 are wound around to fasten the airbag package 53 to the cases 60, 65 and 70. In the illustrated embodiment, each of the fastening bands 62, 67 and 72 includes a retaining pawl at the leading end, and the retaining pawl is each brought into engagement with a retaining hole of the case in order to keep the airbag package 53 and case 60, 65, 70 joined. However, the retaining force of each of the fastening bands 62, 67 and 72 is such as to disengage the retaining pawl from the retaining hole at airbag deployment.

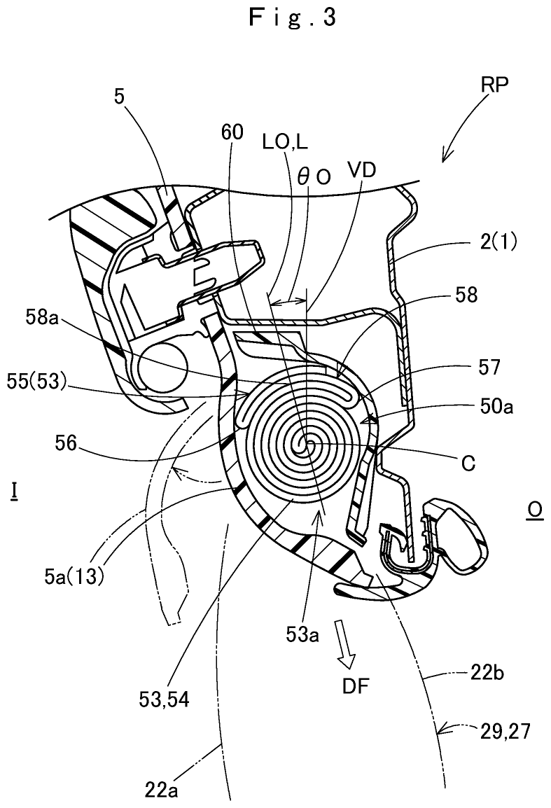

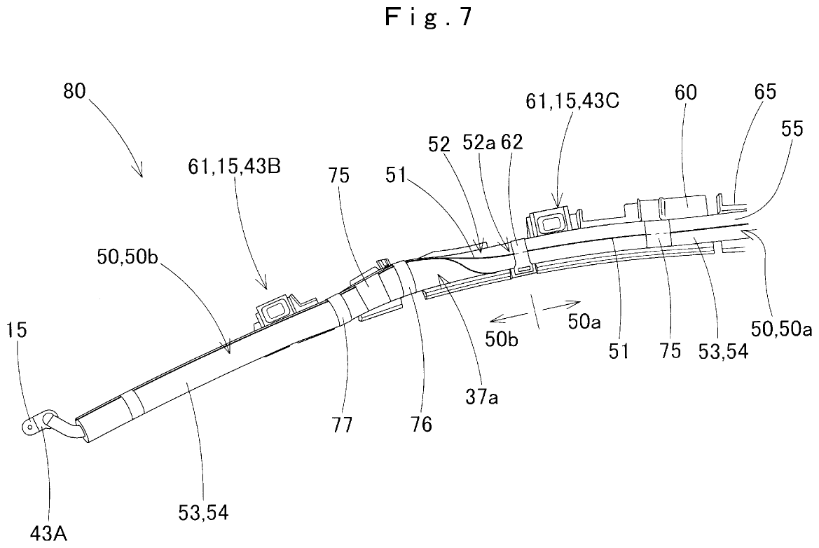

In the illustrated embodiment, as shown in FIGS. 2, 3 and (D) of FIG. 5, the front-end folded portion 50b of the airbag package 53 which is composed of the front-end inflatable region 37 and the front end 28 portion of the front inflatable region 27 is stored in the case 60 in such a state that is twisted or rotated towards an inboard direction I with respect to the general folded region 50a of the airbag package 53 which adjoins the front-end folded region 50b on the rear side, in reference to a lower end 53a of the airbag package 53. The twisted state is described more specifically using a virtual indication thread 51 which is disposed to extend in a front and rear direction in the upper edge 20a of the airbag 20. As shown in FIGS. 6 and 7, in the stored configuration 50 of the airbag 20, the indication thread 51 twists starting from the starting point 52a that is positioned at the location of the fastening band 62 of the case 60. The twisting 52 starts from the starting point 52a, and a portion disposed farther forward than the starting point 52a forms the front-end folded region 50b. The twisting 52 stops at the location of the tape 76, and the front-end folded region 50b stays in the twisted state until the front end.

When the stored configuration 50 of the airbag 20 is formed, i.e. when the airbag package 53 is stored in the cases 60, 65 and 70 in the twisted state, the mounting portions 43B, 43C, 43D and 43E of the airbag 20 are each attached to the mounting seats 61, 66 and 71 of the cases 60, 65 or 70 with the aid of the clips 15, and the inflator 16, which has been coupled with the not-shown mounting bracket, is inserted into the inlet port section 24 of the airbag 20. Then the clamp 17 is used to fasten the inlet port section 24 and inflator 16. Thus an airbag module 80 is formed as shown in FIG. 6.

Thereafter, the airbag module 80 is mounted on the vehicle V as shown in FIG. 1, by bolt-fastening the mounting brackets 14 to the inner panel 2, securing the clips 15 to the inner panel 2, bolt-fastening mounting tongues 68 and 73 of the cases 65 and 70 on the inner panel 2, and bolt-fastening the mounting bracket of the inflator 16 to the inner panel 2.

FIG. 2 and FIG. 3 depict the way the airbag module 80 (i.e. the airbag package 53) is mounted on the vehicle V. As shown in FIG. 3, the general folded portion 50a is mounted on the vehicle V such that a direction L (LO) which heads towards the center C of the rolled portion 54 from the center 58a in a vehicle-width direction of the overlaid portion 58 of the concertina-fold portion 55 is inclined towards an outboard direction O at an angle θO of 20 degrees with respect to a vertical direction VD. As shown in FIG. 2, the front-end folded portion 50b is mounted on the vehicle V such that a direction L (LI) which heads towards the center C of the rolled portion 54 from the center 58a in the vehicle-width direction of the overlaid portion 58 of the concertina-fold portion 55 is inclined towards an inboard direction I at an angle θI of 20 degrees with respect to the vertical direction VD.

In the illustrated embodiment, a straight line extending along the direction L (LO, LI) which heads towards the center C of the rolled portion 54 from the center 58a in the vehicle-width direction of the overlaid portion 58 of the concertina-fold portion 55 passes through a vicinity of the lower end 53a of the airbag package 53 (i.e. the rolled portion 54), in each of the front-end folded region 50b and general folded region 50a.

After the airbag module 80 was mounted on the vehicle V, the not-shown lead wire extending from the predetermined control for actuating the inflator is connected to the inflator 16, and the front pillar garnish 4, roof head liner 5, pillar garnishes 6 and 7 are attached to the inner panel 2 of the vehicle body structure 1. The head-protecting airbag device S is thus mounted on the vehicle V.

When the head-protecting airbag device S as mounted on board is actuated in the event of a side impact crash, an oblique impact crash or a rollover of the vehicle V, the inflator 16 is actuated and feeds an inflation gas G to the airbag 20. The gas G flows through the inlet port section 24, the gas feed path 26, into the inflatable regions 27, 33, 35 and 37. The airbag 20 then pushes and opens the door portion 4b of the pillar garnish 4 and the lower rim 5a of the roof head liner 5 as indicated with double-dotted lines in FIGS. 2 and 3, then is deployed over the windows W1 and W2, middle pillar CP, and the rear pillar RP on the inboard side, as indicated with double-dotted lines in FIG. 1.

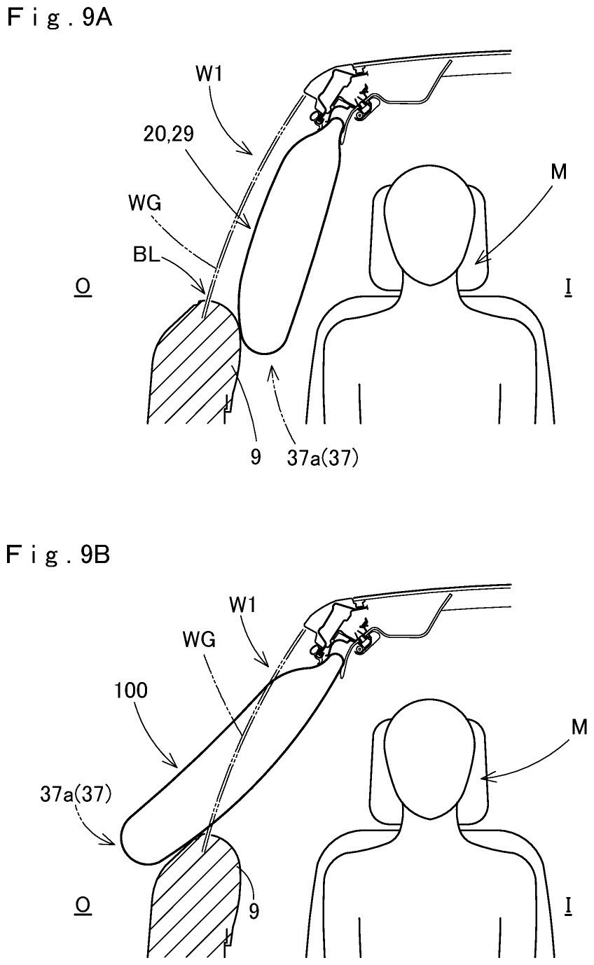

In the head-protecting airbag device S of the illustrated embodiment, although the front-end folded region 50b which is deployable farther downwardly than the beltline BL of the front side window W1 is twisted towards the inboard direction I with respect to the general folded region 50a in reference to the lower end 53a of the airbag package 53, the twisted angle is under 90 degrees (more particularly, the twisted angle is a sum of the inclination angles θO and θI with respect to the vertical direction VD, i.e. 40°). This configuration is able to deploy the airbag 20 towards the inboard direction I without breaking the front pillar garnish 4 and/or letting the front pillar garnish 4 fly towards the interior of the vehicle, as indicated with double-dotted lines in FIG. 2. If the front-end folded region 50b is twisted with respect to the general folded region 50a at an angle over 90 degrees, the front-end folded region 50b would hit a vicinity of the hinge portion 4c of the pillar garnish 4 and cause disengagement of the clip 4d from the inner panel 2. Since the front-end folded region 50b is twisted towards the inboard direction I with respect to the general folded region 50a in the mounted state, a lower end 37a region (as an extended inflatable region) of the front-end inflatable region 37 is deployed over the interior wall disposed immediately beneath the beltline BL of the front side window W1 (in other words, over the door trim 9), not on the outboard side, even if the window W1 (window pane WG) is open as shown in FIG. 9A. Therefore, the airbag 20 is able to arrest an occupant M which moves towards an outboard direction in a steady fashion.

If the front-end folded region 50b is mounted on the vehicle V in a same way as the general region 50a, i.e. in an untwisted state with respect to the general region 50a, the lower end 37a region (i.e. the extended inflatable region) of the front-end inflatable region 37 may protrude outwardly from the open window W1 as in an airbag 100 shown as a comparative example in FIG. 9B, since the front pillar FP in which the front-end folded region 50b is stored is disposed proximate to the door trim 9 as goes forward, as shown in FIG. 8. This will lead to failure of protection of the head of the occupant.

Therefore, the head-protecting airbag device S of the illustrated embodiment is able to deploy the airbag 20 smoothly although the airbag 20 includes the front-end inflatable region 37 which extends downward beyond the beltline BL in the front end portion. In the head-protecting airbag device S of the illustrated embodiment, the airbag package 53, i.e. the stored configuration 50 of the airbag 20, is configured such that the front-end folded region 50b is twisted towards the inboard direction I at an angle of 40 degrees (i.e. θO+θI=40°), i.e. under 45 degrees, with respect to the general folded region 50a.

This configuration will further enable the lower end 37a region (as the extended inflatable region) of the front-end inflatable region 37 to be deployed in the inboard side of the door trim 9 beneath the beltline BL even if the window W1 is open, without a fear of breakage and/or disengagement of the front pillar garnish 4.

In the head-protecting airbag device S of the illustrated embodiment, the airbag 20 or airbag package 53 is housed in the cases 60, 65 and 70, and is coupled with the cases 60, 65 and 70 with the tapes 75, 76 and 77 and the fastening bands (i.e. fastening members) 62, 67 and 72 that are configured to stop fastening at airbag deployment. Further, the fastening band 62, which is one of the fastening members, is disposed at the starting point 52a of twisting of the front-end folded region 50b.

With this configuration, the front-end folded region 50b and general folded region 50a of the airbag package 53 are coupled with the cases 60, 65 and 70 with the fastening bands (or fastening members) 62, 67 and 72 and tapes 75, 76 and 77 in a steady fashion, and the fastening band 62 disposed at the starting point 52a of twisting of the front-end folded region 50b securely fixes the starting point 52a of the twisting and delimits the twisted front-end folded region 50b from the untwisted general folded region 50a in a steady fashion. This will help deploy each of the front-end folded region 50b and general folded region 50a in a desired deployment fashion.

Moreover, the stored configuration 50 of the airbag 20 (i.e. the airbag package 53) is configured such that an initial deployment direction DN (FIG. 2) of the front-end folded region 50b, which is a direction that the front-end folded region 50b deploys in an initial stage of inflow of an inflation gas G or airbag deployment, is directed towards an inboard direction I at an angle θI with respect to the vertical direction VD, whereas an initial deployment direction DF (FIG. 3) of the general folded region 50a, which is a direction that the general folded region 50a deploys in the initial stage of inflow of an inflation gas G or airbag deployment, is directed towards an outboard direction O at an angle θO with respect to the vertical direction VD.

This configuration will steadily deploy the front-end folded region 50b towards an inboard direction I and deploy the general folded region 50a towards an outboard direction O in the initial stage of airbag deployment, as indicated with double-dotted lines in FIGS. 2 and 3. As a consequence, the front-end inflatable region 37 will be steadily deployed in the inboard side of the door trim 9 beneath the beltline BL of the front side window W1, while a rear portion 29 of the front inflatable region 27 and the rear inflatable region 33, which is disposed at the rear of the front-end inflatable region 37, will be smoothly deployed along the middle pillar CP and rear side window W2, such that the airbag 20 is deployed between the rear side window W2 and the head of an occupant even if the head is located in proximity to the window W2.

In the head-protecting airbag device S of the illustrated embodiment, especially, the airbag 20 further includes the initial unfolding region 23 that is disposed in the upper edge 20a of the airbag 20 and receives an inflation gas G initially, and the initial unfolding region 23 is folded into a concertina on a plurality of creases 56 and 57 extending in a front and rear direction to form the concertina-fold portion 55. The concertina-fold portion 55 is disposed over the upper surface of the rolled portion 54 in the airbag package 53, and includes the overlaid portion 58 which is a portion disposed between adjoining creases 56 and 57 of the concertina-fold portion 55. In each of the front-end folded region 50b and general folded region 50a of the airbag package 53, the initial deployment direction DN, DF is determined by the direction LI, LO that heads towards the center C of the rolled portion 54 from the center 58a in a vehicle-width direction of the overlaid portion 58. In the illustrated embodiment, the initial deployment direction DF of the general folded region 50a is directed towards an outboard direction O at an angle θO of 20 degrees from the vertical direction VD, and the initial deployment direction DN of the front-end folded region 50b is directed towards an inboard direction I at an angle θI of 20 degrees from the vertical direction VD.

With the above configuration, when an inflation gas G flows into the initial unfolding region 23 in the initial stage of airbag deployment, in each of the front-end folded region 50b and general folded region 50a, the overlaid portion 58 of the initial unfolding region 23 pushes the rolled portion 54 towards the direction L (LI, LO) heading towards the center C of the rolled portion 54 from the center 58a in the vehicle-width direction of the overlaid portion 58. The direction L (LI, LO) determines the initial deployment direction DN, DF. Accordingly, each of the front-end folded region 50b and general folded region 50a can be mounted on the vehicle V so as to be deployed in a desired initial deployment direction DN, DF by arranging the overlaid portion 58 of the concertina-fold portion 55 in each of the front-end folded region 50b and general folded region 50a at a corresponding position when mounting the airbag package 53 on the vehicle V.

What is claimed is:

1. A head-protecting airbag device adapted to be mounted on a vehicle which has, on a side, a front pillar which extends obliquely upward toward a rear of the vehicle, a front side window, a middle pillar, a rear side window, and a beltline which forms a lower edge of the front side window,
the airbag device comprising an airbag that includes an extended inflatable region which is disposed in a front end portion of the airbag and is deployable over an interior wall of the vehicle disposed immediately beneath the beltline, the airbag being folded to form an airbag package for mounting on an upper periphery of the front side window including a lower rim of the front pillar, and in an upper periphery of the rear side window, on an inboard side, so as to unfold downward and be deployed over at least the front side window, the middle pillar, and the rear side window when fed with an inflation gas,
wherein the airbag package includes:
a rolled portion that is rolled in an up and down direction on an outboard side of the airbag;
a front-end region of the rolled portion that is adapted to be stored in the front pillar, wherein the extended inflatable region is disposed in the front-end region; and
a general region of the rolled portion that is disposed at the rear of the front-end region,
wherein the front-end region is twisted towards an inboard direction at an angle under 90 degrees with respect to the general region in reference to a lower end of the airbag package.

2. The head-protecting airbag device of claim 1, wherein the front-end region of the rolled portion is twisted towards the inboard direction at an angle under 45 degrees with respect to the general region.

3. The head-protecting airbag device of claim 1, wherein:
the airbag package is stored in one or more cases and fastened together with the cases with one or more fastening members that are configured to stop fastening at airbag deployment; and
one of the fastening members is disposed at a starting point of twisting of the front-end region.

4. The head-protecting airbag device of claim 1, wherein, the airbag package is configured such that an initial deployment direction of the front-end region, which is a direction that the front-end region deploys in an initial stage of airbag deployment, is directed towards an inboard direction with respect to a vertical direction, whereas an initial deployment direction of the general region, which is a direction that the general region deploys in the initial stage of airbag deployment, is directed towards an outboard direction with respect to the vertical direction.

5. The head-protecting airbag device of claim 4, wherein:
the airbag further includes an initial unfolding region that is disposed in an upper edge of the airbag and receives an inflation gas initially, and that is folded into a concertina on a plurality of creases extending in a front and rear direction, thus forming a concertina-fold portion;
the concertina-fold portion is disposed over an upper surface of the rolled portion of the airbag package, and includes an overlaid portion which is a portion disposed between adjoining creases of the concertina-fold portion; and
in each of the front-end region and general region, the initial deployment direction is determined by a direction that heads towards a center of the rolled portion from a center in a vehicle-width direction of the overlaid portion.
